(19) United States
(12) Patent Application Publication
(10) Pub. No.: US 2012/0306236 A1
(43) Pub. Date: Dec. 6, 2012

(54) MODULAR TRUCK BODY WITH HINGED SIDE PANELS

(75) Inventors: Bruce Skipper, Mohnton, PA (US); John Karl Howley, Reading, PA (US); Christopher E. Braungard, Ephrata, PA (US); Mark W. Robinson, Wyomissing, PA (US)

(73) Assignee: Reading Truck Body, Inc., Reading, PA (US)

(21) Appl. No.: 13/310,281

(22) Filed: Dec. 2, 2011

Related U.S. Application Data
(60) Provisional application No. 61/491,597, filed on May 31, 2011.

(51) Int. Cl. B62D 33/04

(52) U.S. Cl. 296/193.04

(57) ABSTRACT

A truck body includes two opposing side wall panels, a roof panel, and a floor panel, at least two joints of which are connected by hinges. A first hinge connects one of the side panels to the roof panel. A second hinge connects a second one of the side panels to the floor panel. Thus, the two sides, roof and floor may form an open-ended rectangular box when assembled, but they may lie flat when disassembled. The hinges may include one or more rotating hinges, slip hinges or other types of hinge.

### RELATED APPLICATIONS

This application claims priority to U.S. Provisional Patent Application No. 61/491,597, filed Dec. 3, 2010, the disclosure of which is incorporated herein by reference in its entirety.

### BACKGROUND

This disclosure relates to, generally and in various embodiments, to a modular truck body. More specifically, this disclosure relates to a modular truck body having one or more hinged assemblies.

There are many types of truck bodies which can be mounted to the chassis of a truck. For example, a common type of truck body utilized in the building trades is a pre-assembled truck body which has a floor, a bulkhead or front end cap positioned near the cab of the truck, side panels positioned along the left and right sides of the truck, and a rear end cap positioned at the back of the truck. For such pre-assembled truck bodies, the floor, the end caps, and the side panels are generally fastened to one another.

Due to the size and weight of the pre-assembled truck bodies, the components are generally assembled at a central location and sent out as a finished truck body to be installed on a vehicle frame. For a variety of reasons, one or more of the components of the pre-assembled truck body may incur damage during shipping. For example, it is not uncommon for one of the side panels to become dented, scratched, or otherwise damaged. Because various components of the pre-assembled truck body are welded to one another, it may not be practical to attempt to replace only the damaged component. Rather, the entire pre-assembled truck body is often replaced by another pre-assembled truck body, even when only one of the components is damaged. The need to replace the entire pre-assembled truck body is both time-consuming and expensive.

When shipping a truck body from one location to another, it is desirable to reduce the shipping size so that multiple truck bodies can be delivered in a single shipment. Once assembled, the size of the truck body necessitates careful shipping and a delivery vehicle is generally limited to only hauling one truck body.

An alternative is to send each component of a truck body to the customer and the customer constructs the truck body. However, this may require a high degree of skill with metal work (e.g., welding) as well as a large number of people to assemble the heavy components of the truck body. Therefore, it is also desirable to reduce assembly time when a truck body arrives at its delivery location unassembled.

This document describes a truck body assembly that is directed to some of the above, or other, problems.

### SUMMARY

In an embodiment a truck body includes two opposing side wall panels, a roof panel, and a floor panel. A first hinge connects a first one of the side panels to the roof panel either directly or indirectly through one or more joining members such as a rail. A second hinge connects a second one of the side panels to the floor panel, either directly or indirectly through one or more joining members such as a rail. Thus, the two sides, roof and floor may form an open-ended rectangular box when assembled, but they may lie flat when disassembled. When assembled, a first end cap may be directly or indirectly secured to the panels at a first end, while a second end cap may be directly or indirectly secured to the panels at a second end.

In some embodiments, either or both of the hinges may include or be connected to a hinged top rail formed of: (i) a first rail member that is secured to the roof or floor panel and to a first portion of the hinge; and (ii) a second rail member that is connected to one of the side panels and to a second portion of the hinge. In other embodiments, either or both of the hinges may include a slip hinge that comprises a first hinge element having a groove formed by opposing wall members, wherein one of the opposing wall members is shorter than the other of the opposing wall members, and a second hinge element having an arm member that extends into the groove and secures a side panel to the floor or roof panel.

### BRIEF DESCRIPTION OF THE DRAWINGS

FIG. 1 illustrates a modular truck body according to an embodiment.

FIG. 2 illustrates an exploded view of the truck body of FIG. 1.

FIG. 3 illustrates an exploded view of a first modular truck body assembly according to an embodiment.

FIG. 4 illustrates a hinge according to an embodiment of the invention.

FIG. 5 illustrates the hinge of FIG. 4 as the parts rotate about a pin.

FIG. 6 illustrates a roof panel assembly according to an embodiment.

FIG. 7 illustrates an exploded view of a second modular truck body assembly including a side panel and floor panel according to an embodiment.

FIG. 8 illustrates an alternate embodiment of a side panel and floor panel.

FIG. 9 illustrates the embodiment of FIG. 8 with the side panel attached to the floor panel.

FIG. 10 illustrates a floor panel assembly according to an embodiment.

FIG. 11 illustrates a rear end cap according to an embodiment.

FIG. 12 illustrates a front end cap according to an embodiment.

### I. DETAILED DESCRIPTION

This disclosure is not limited to the particular methodologies, systems and materials described, as these may vary. The terminology used in this description is for the purpose of describing the particular versions or embodiments only, and is not intended to limit the scope. In addition, the word “comprising” as used in this document is intended to mean “including but not limited to.” Unless defined otherwise, all technical and scientific terms used herein have the same meanings as commonly understood by one of ordinary skill in the art.

In an embodiment, a modular truck body assembly may include a first assembly that includes a roof panel, a side wall panel and a hinged top rail. The modular truck body may also include a second assembly comprising a floor panel, a second side panel and a bottom rail. The bottom rail may be hinged. Alternatively, the second side panel may include a slip hinge that fits over and accepts a member of the bottom rail. The modular truck body may also include a front end cap and a rear end cap. The panels and end caps may be made of a rigid material such as aluminum, fiberglass, steel and/or other suitable materials to serve as wall panels. Similarly, some or all of the panels may be made of a rigid frame covered with a non-rigid material. For example, the wall panels may include an aluminum frame covered in a high strength fabric or plastic sheeting to reduce weight.

The roof panel may also be made of similar materials as the wall panels. The roof panel may also be formed of a plurality of slats or roof bows made of a rigid material such as aluminum or steel, and covered by a covering made of fiberglass, fabric, canvas, metal or other suitable material. The roof bows provide structural support for the lighter top material of the roof. The floor panel may be made of a plurality of cross members to provide structural support, along with a set of floor boards, which may be made of wood, metal, plastic or any suitable composite material to serve as a sturdy floor for the truck body. Various components of the modular truck body are illustrated in the figures, and explained in greater detail in the following description.

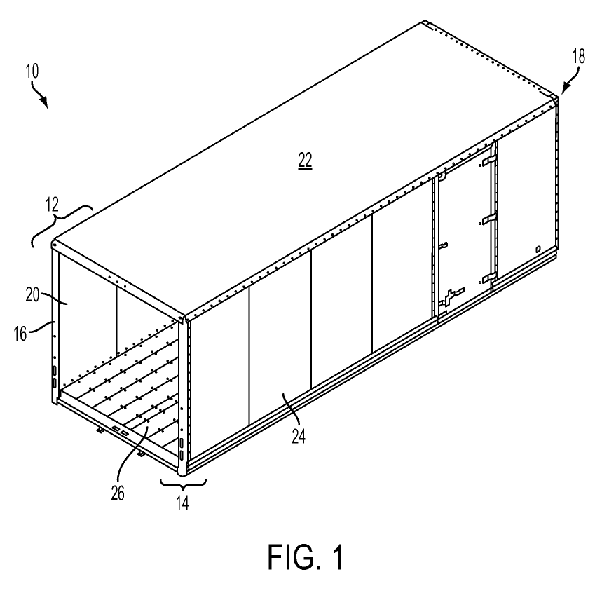

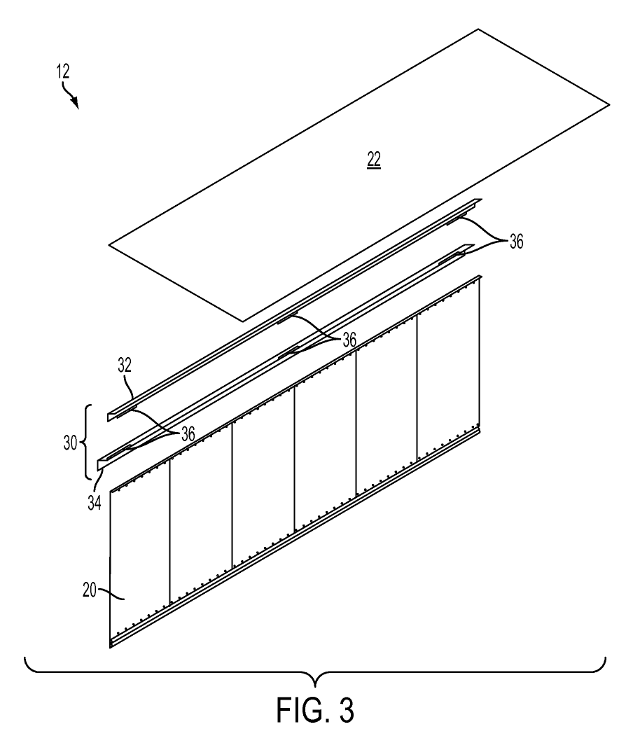

FIG. 1 illustrates a modular truck body 10. The modular truck body 10 may include a first assembly 12, a second assembly 14, a rear end cap 16, and a front end cap 18 (only partially shown in FIG. 1). The first assembly 12 may include a first side-wall panel 20 and a roof panel 22. The second assembly 14 may include a second wall panel 24 and a floor panel 26. Additionally, each of the first assembly 12 and second assembly 14 may include additional hinged rails (as shown in FIGS. 3, 4, 5 and 6) configured to fold and unfold the assemblies.

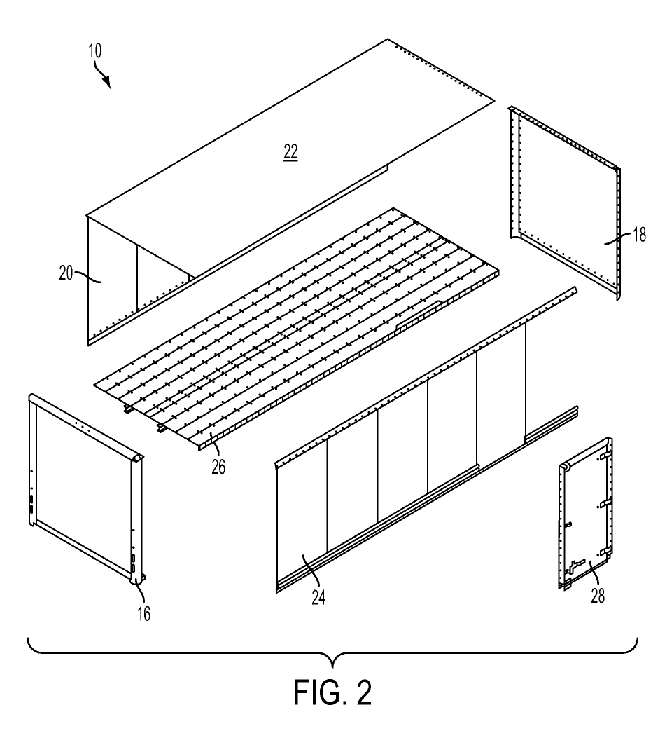

FIG. 2 illustrates an exploded view of the modular truck body 10 for clarity purposes. It should be noted that the first or second wall panel, as shown in second wall panel 24, may include one or more doors 28 depending upon the configuration and intended purpose of the modular truck body 10. Additionally, it should be noted that rear end cap 16 is shown in an open configuration without any doors; however, one or more doors may be included in the rear end cap. Each of the various components of modular truck body 10 are explained in greater detail in the following discussions.

FIG. 3 illustrates an exploded view of first assembly 12. Positioned between the first wall panel 20 and the roof panel 22 may be a hinged top rail 30. The hinged top rail 30 may include at least two rail elements 32 and 34, as well as plurality of hinges 36. A first rail element 32 may be configured to be attached to the roof panel 22 and secured to a first portion of each of the plurality of hinges 36. A second rail element 34 may be configured to be attached to the first wall panel 20 as well as a second portion of each of the plurality of hinges 36. When the first assembly 12 is in a folded position, the two rail elements 32 and 34 of the hinged top rail 30 rotate so that the roof panel 22 may pivot about the hinges 36 and fold over to the first wall panel 20. Conversely, when the first assembly 12 is in an unfolded position, a turn or overlap of the first rail element 32 may rest on a turn of the second rail element 34, thereby preventing the first assembly from opening too far (e.g., beyond about 90 degrees) and positioning the first wall panel 20 and the roof panel 22 at an appropriate unfolded angle (e.g., at or around 90 degrees).

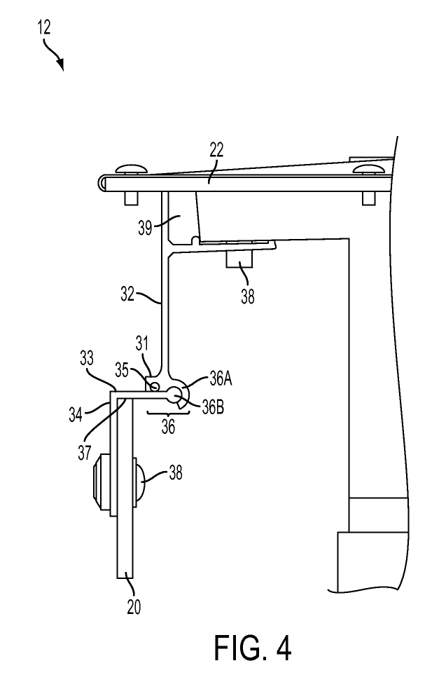

FIG. 4 shows a detailed view of hinged top rail 30 in an open (unfolded) view. When unfolded, an outer edge 31 of the first rail element 32 may overlap an outer edge 33 of the second rail element 34. Alternatively, the outer edge 33 of the second rail element 34 may overlap the outer edge 31 of the first rail element 32. A weather-resistant seal 33, such as very high bond (VHB) tape or open-cell foam weather stripping or rubber or other resilient material may be placed along the first rail element 32 and/or the second rail element 34 to provide a weather-resistant seal between the two elements of the hinged top rail 30 when the first assembly 12 is in an unfolded position.

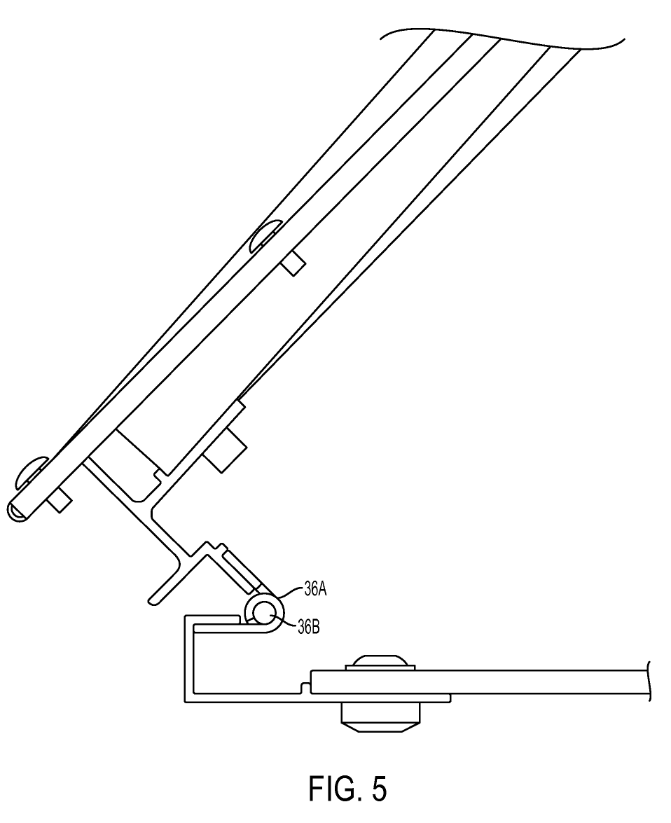

Depending on the size and required strength of the modular truck body 10, the first assembly 12 may include any number of hinges 36 along the hinged top rail 30. For example, the modular truck body 10 may have three hinges 36 (as shown in FIG. 2), such that one is positioned centrally along the length of the modular truck body, a second hinge is positioned near a front end of the modular truck body and a third hinge is positioned near a rear end of the modular truck body. As shown in FIG. 4, the hinge 36 may have a pin and socket configuration. A socket 36A may surround and rotate about a pin 36B as shown in FIG. 5. Other hinge configurations and numbers of hinges are possible. For example, a single hinge (e.g., a piano hinge) may be provided along the entire length of the modular truck body 10.

Referring again to FIGS. 3 and 4 the hinged top rail 30 may be attached to the first wall panel 20 and the roof panel 22 via one or more fasteners 38 along the length the hinged top rail. For example, the first wall panel 20 may fit into a recess 37 defined by the shape of the second rail element 34 and may be attached to the second rail element via one or more fasteners 38. Similarly, the roof panel 22 may fit into a recess 39 defined by the shape of the first rail element 32 and may be attached to the first rail element via one or more fasteners 38. The fasteners 38 may include bolts, rivets, welded points, or other suitable attachment means.

In an embodiment, the roof panel 22 includes rivets or pins such as rivets that extend downward for attachment of the cover material to the first rail element 32 of the hinged top rail 30. An adhesive such as tape may be used to fasten the roof sheet to the roof bows.

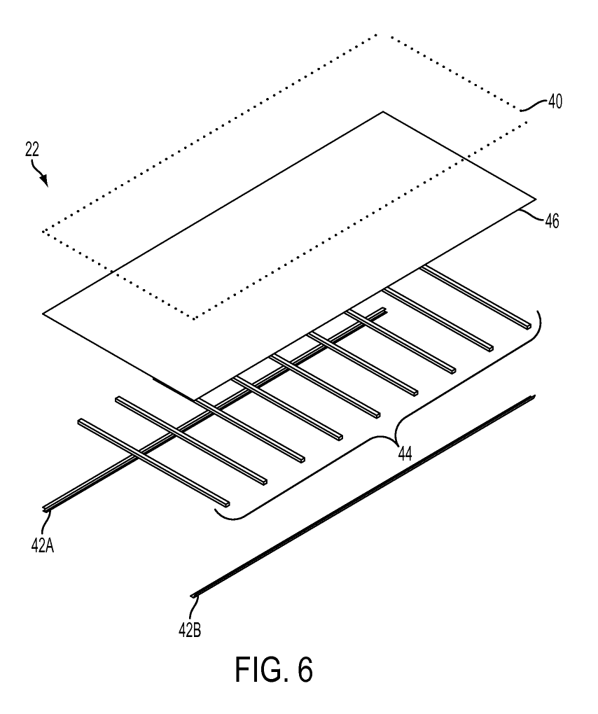

FIG. 6 illustrates an exploded view of a roof panel 22. The roof panel 22 may include two or more longitudinal support rails 42A and 42B. A plurality of slats or roof bows 44 made of a rigid material such as aluminum or steel, and covered by a covering made of fiberglass, fabric, canvas, metal or other suitable material may be positioned between the longitudinal support rails 42A and 42B. The roof bows 44 may be bolted, welded or otherwise rigidly attached to the longitudinal support rails 42A and 42B. The roof bows 44 may provide structural support for the top covering panel 46 of the roof. A plurality of rivets, pins, bolts, or other similar fasteners (collectively shown by element 40) may be used to attach the top covering panel 46 to the longitudinal support rails 42A and 42B. It should be noted the configuration shown herein for the assembly of roof panel 22 is shown by way of example only.

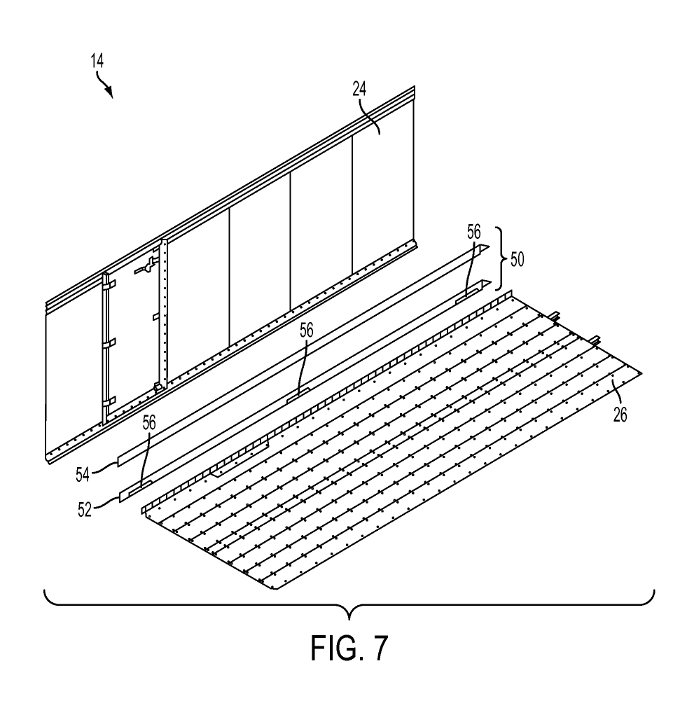

FIG. 7 illustrates an exploded view of an embodiment of second assembly 14. Positioned between the second wall panel 24 and the floor panel 26 may be a hinged bottom rail 50. The hinged bottom rail 50 may include at least two rail elements 52 and 54, as well as plurality of hinges 56. A first rail element 52 may be configured to be attached to the floor panel 26 and secured to a first portion of each of the plurality of hinges 56. A second rail element 54 may be configured to be attached to the second wall panel 24 as well as a second portion of each of the plurality of hinges 56. When the second assembly 14 is in a folded position, the two rail elements 52 and 54 of the hinged bottom rail 50 separate so that the second wall panel 24 may pivot over the hinges 56 and fold down to the floor panel 26. Conversely, when the second assembly 14 is in an unfolded position, a turn or overlap of the first rail element 52 may rest on a turn of the second rail element 54, thereby preventing the second assembly 14 from opening too far and positioning the second wall panel 24 and the floor panel 26 at an appropriate unfolded angle (e.g., at or around 90 degrees).

When unfolded, an outer edge of the first rail element 52 may overlap an outer edge of the second rail element 54. Alternatively, the outer edge of the second rail element 54 may overlap the outer edge of the first rail element 52. A weather-resistant seal, such as VHB tape or open-cell foam weather stripping may be placed along the first rail element 52 and/or the second rail element 54 to provide a weather-resistant seal between the two elements of the hinged bottom rail 50 when the second assembly 14 is in an unfolded position.

Depending on the size and required strength of the modular truck body 10, the second assembly 14 may include any number of hinges 56 along the hinged bottom rail 50. For example, the modular truck body 10 may have three hinges 56. A socket and pin hinge (i.e., hinge 36 as shown in FIG. 3) may be included in hinged bottom rail 50. However, other hinge configurations and numbers of hinges are possible. For example, a single hinge (e.g., a piano hinge) may be provided along the entire length of the modular truck body 10.

The hinged bottom rail 50 may be attached to the second wall panel 24 and the floor panel 26 via one or more fasteners (i.e., fasteners 38 as shown in FIG. 4) along the length the hinged bottom rail. The fasteners may include bolts, rivets, welded points, or other suitable attachment means.

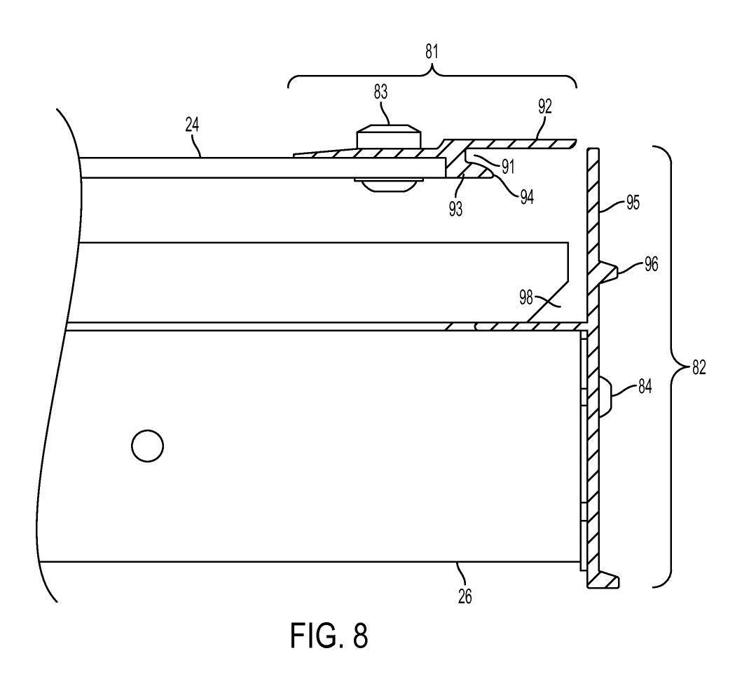

FIG. 8 illustrates an alternate assembly by which side panel 24 may be secured to the floor panel 26 with a slip hinge that includes a first hinge element 81 and a second hinge element 82. First hinge element 81 may be attached to the side panel 24 by one or more fasteners 83 such as a bolt, rivet or weld. Similarly, second hinge element 82 may be attached to the floor panel 26 by one or more fasteners 84. One of the hinge elements (as shown in this example, side hinge element 81) includes a groove 91 formed by first and second parallel wall member 92, 93. The side hinge element 81 may be attached to the side panel 24, while its groove 91 may be sized to fit over an arm member 95 of the floor hinge element 82.

One of the first hinge element's wall members 92 may be longer than the other wall member 93. The shorter wall member 93 may include an interior bezel or curved wall portion 94 to assist in placement of that hinge element 91 over the arm member 95 of the other hinge element 92. The arm 95 of the second hinge element 82 may include a ledge 96, which extends outward from the arm member 95 and may serve as a stop to help support the longer wall member 92 of the first hinge element 81. Thus, the first hinge element's groove 91 may pivot over and accept the second hinge element's arm 95 to connect the side wall and floor member.

The second hinge element 82 may be generally “tee” shaped so that a stem 98 of the hinge element 92 is perpendicular to the arm 95 and extends over, under or into the floor member for additional support. Rail element 81 is not necessarily physically attached to rail element 82 until the body 10 is fully assembled.

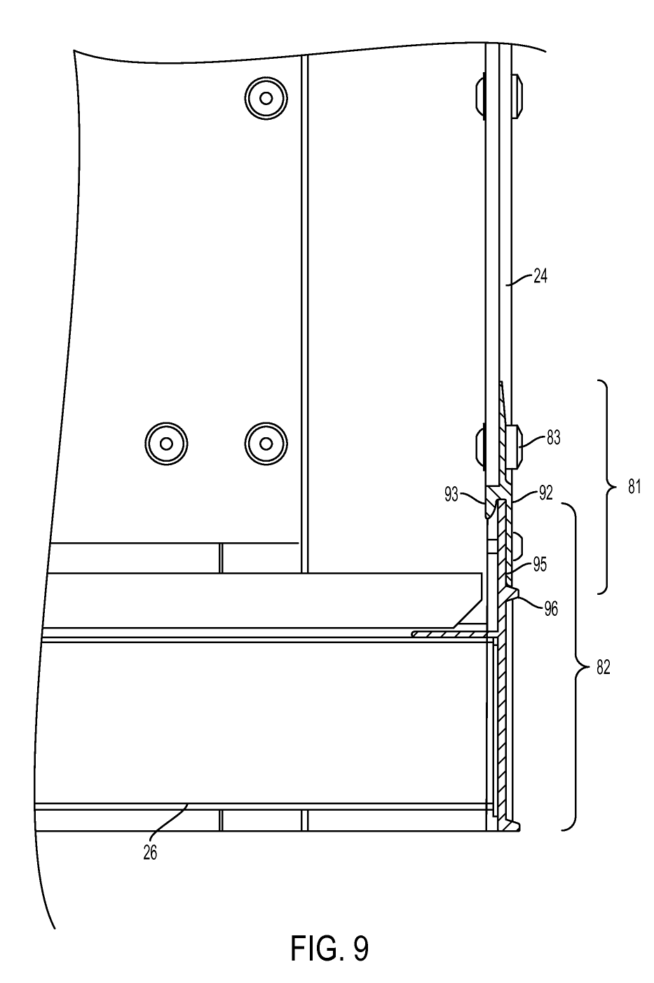

FIG. 9 illustrates the embodiment of FIG. 8 wherein the side panel's slip hinge elements are placed together and may be secured to its corresponding wall or rail with bolts, rivets or other suitable attachment means. A weather-resistant seal (VHB tape) may be applied between rail element 81 and 82.

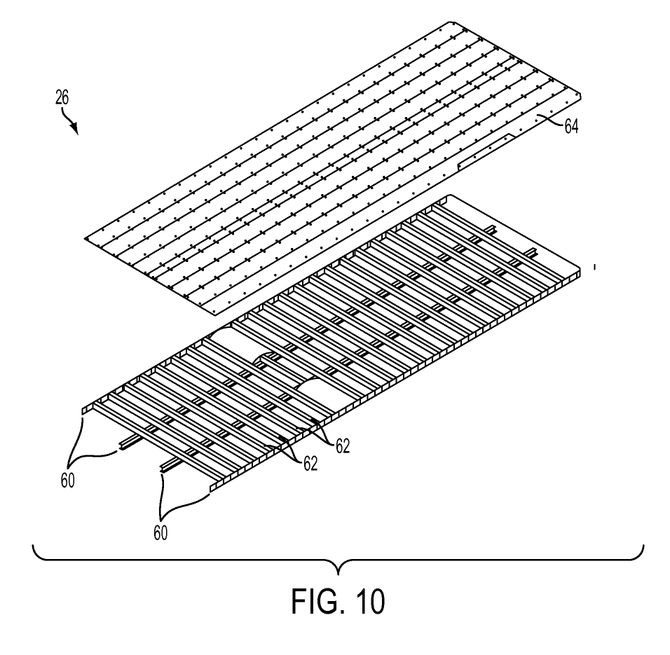

FIG. 10 illustrates an exploded view of a floor panel 26. The floor panel 26 may include a plurality of longitudinal support rails 60 rigidly attached to a plurality of cross-member supports 62. The configuration of the longitudinal support rails 60 and the cross-member supports 62 may provide structural support for a set of floor boards 64 as well as the other components of modular truck body 10. The set of floor boards 64 may be made of wood, metal, plastic or any suitable composite material to serve as a sturdy floor for the modular truck body 10 and may be attached to the longitudinal support rails 60 and the cross-member supports 62 via a plurality of fasteners such as bolts, rivets, welded points, or other suitable attachment means. Additionally, the configuration of the longitudinal support rails 60 and the cross-member supports 62 may be arranged and positioned such that any components of a truck frame onto which the modular truck body 10 is to be mounted are accommodated (e.g., tire wells). It should be noted the configuration shown herein for the assembly of floor panel 26 is shown by way of example only.

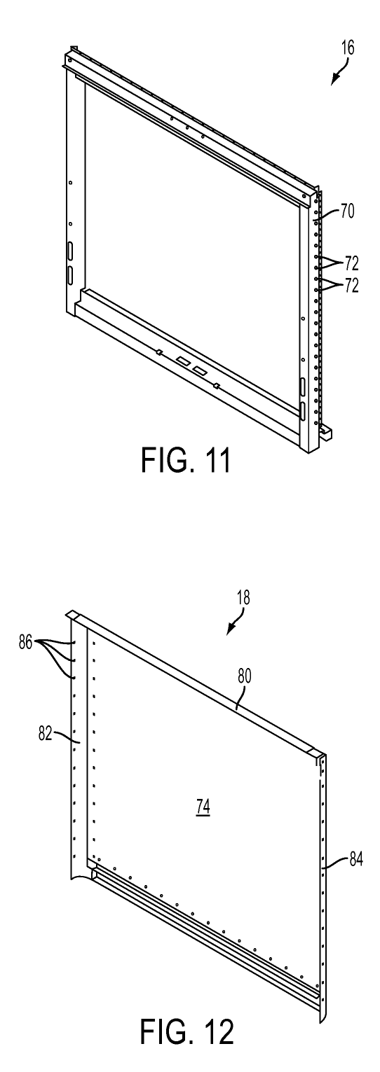

FIG. 11 illustrates a rear end cap 16. The rear end cap 16 may include a frame structure 70 that surrounds or is attached to at least two sides of the rear end cap. The frame structure may include a plurality of attachment points 72 for attaching the rear end cap 16 to the other components of the modular truck body 10 via one or more fasteners (e.g., bolts, rivets, welded points, or other suitable attachment means). As shown in FIG. 11, the rear end cap does not include any doors. It should be noted the rear end cap 16 is shown by way of example only and may include one or more doors depending on the configuration and intended purpose of modular truck body 10. Additionally, the rear end cap 16 may include various other components such as taillights, turn signals, mounting brackets for a license plate or hazard placard, or other similar components.

FIG. 12 illustrates a front end cap 18. The front end cap 18 may include a wall member 74 and a frame member 76 that surrounds at least three sides of the wall member. The frame structure 76 may be secured to the wall member 74 via one or more fasteners and may include a top rail 80 that is angled inward and provides a lip to receive a portion of the roof panel 22 during assembly. The frame member 76 may also include at least two side angle members 82 and 84, each of which is securely attached to the wall member 74 and is angled inward toward a lip that will tightly fit over or under the side wall panels 20 and 24. Each lip may include a plurality of connection means 86 for connecting to its corresponding wall panel 20, 24 or roof panel 22.

When installed, each of rear end cap 16 and front end cap 18 may be sealed with VHB tape or open cell foam weather stripping, or other suitable sealing means. The sealant may be placed along either frame structures 70 or 76, thus creating a seal between either the rear end cap 16 or front end cap 18 and an attached modular truck body 10 component (e.g., roof panel 22).

Using the invention as described herein, constructing the modular truck body 10 may be performed in several structured steps. First, each of the first assembly 12 and the second assembly 14 may be unfolded and secured. For example, the first assembly 12 may be unfolded such that the first wall panel 20 and the roof panel 22 are at or about 90 degrees to each other. The first assembly 12 may then be fastened and secured. An additional support such as a temporary brace may be used to hold the first assembly in the open, unfolded position. Similarly, the second assembly 14 may be unfolded such that the second wall panel 24 and the floor panel 26 are at or about 90 degrees to each other. The second assembly 14 may then be fastened and secured. Each assembly 12 and 14 may then be attached to each other via one or more fasteners. For example, roof panel 22 (of the first assembly 12) and second wall panel 24 (of the second assembly 14) may be configured such that they bolt together via a plurality of corresponding attachment points. Once the assemblies 12 and 14 are attached, the rear end cap 16 and the front end cap 18 may be attached. Once the modular truck body 10 is assembled, the body may be attached to a vehicle frame resulting in a completed truck.

Variations of the above-disclosed and other features and functions, or alternatives thereof, may be combined into many other different systems or applications. Variations presently unforeseen or unanticipated alternatives, modifications, variations or improvements therein may be subsequently made by those skilled in the art, each of which is also intended to be encompassed by the disclosed embodiments.

1. A modular truck body comprising:
a first assembly comprising a first wall panel, a roof panel and a hinged top rail that is foldably connected to the first wall panel and the roof panel;
a second assembly comprising a floor panel, a second wall panel and a bottom rail that connects to the floor panel and the second wall panel;
a front end cap; and
a rear end cap.

2. The modular truck body of claim 1, wherein the hinged top rail comprises:
a first rail member fixedly secured to the roof panel and to a first portion of at least one hinge; and
a second rail member fixedly connected to the first wall panel and to a second portion of the at least one hinge.

3. The modular truck body of claim 2, wherein the first rail member and the second rail member each comprise:
a plurality of openings that are positioned to correspond to each other and accept a fastener when the first assembly is in an unfolded position.

4. The modular truck body of claim 2 further comprising a weather-resistant seal that is secured to either the first rail member or the second rail member.

5. The modular truck body of claim 1, wherein the bottom rail comprises:
a first rail member secured to the floor panel and to a first portion of at least one hinge; and
a second rail member secured to the second wall panel and to a second portion of the at least one hinge.

6. The modular truck body of claim 5, wherein the first rail member and the second rail member each comprise:
a plurality of openings that are positioned to correspond to each other and accept a fastener when the first assembly is in an unfolded position.

7. The modular truck body of claim 5 further comprising a weather-resistant seal that is secured to either the first rail member or the second rail member.

8. The modular truck body of claim 1, further comprising:
a slip hinge comprising a first hinge element having a groove and a second hinge element having an arm member, wherein the groove is configured to pivot over and accept the arm member to secure the second wall panel to the floor panel.

9. The modular truck body of claim 1, wherein the front end cap comprises:
a wall member; and
a frame structure.

10. The modular truck body of claim 1, wherein the frame structure comprises:
a top rail; and
a plurality of angled side members.

11. The modular truck body of claim 1, wherein the hinged top rail and the hinged bottom rail comprise a plurality of hinges.

12. A truck body, comprising:
a first wall panel;
a second wall panel;
a roof panel;
a floor panel;
a first hinge that connects the first wall panel to the roof panel; and
a second hinge that connects the second wall panel to the floor panel.

13. The truck body of claim 12, wherein the first hinge comprises:
a first rail member secured to the roof panel and to a first portion of at least one hinge; and
a second rail member secured to the first wall panel and to a second portion of the at least one hinge.

14. The truck body of claim 13, wherein the first rail member and the second rail member each comprise:
a plurality of openings that are positioned to correspond to each other and accept a fastener when the first assembly is in an unfolded position.

15. The truck body of claim 13, further comprising a weather-resistant seal that is secured to either the first rail member or the second rail member.

16. The truck body of claim 12, further comprising:
a front end cap; and
a rear end cap.

17. The truck body of claim 12, wherein the second hinge comprises a slip hinge that comprises:
a first hinge element having a groove formed by opposing wall members, wherein one of the opposing wall members is shorter than the other of the opposing wall members;
a second hinge element having an arm member that extends into the groove and secures the second wall panel to the floor panel.

18. The truck body of claim 17, wherein:
a first one of the opposing wall members is longer than a second one of the opposing wall members;
the arm member includes a stop that contacts an end of the first opposing wall member when the second wall panel when the arm member is extended into the groove.

19. The truck body of claim 17, wherein the groove is configured to pivot over and accept the arm member.

20. A truck body, comprising:
a first wall panel;
a second wall panel;
a roof panel;
a floor panel;
a first hinge that connects the first wall panel to the roof panel;
a second hinge that connects the second wall panel to the floor panel;
a first end cap that is secured to each of the panels; and
a second end cap that is secured to each of the panels.

21. The truck body of claim 20, wherein the first hinge comprises:
a first rail member fixedly secured to the roof panel and to a first portion of at least one hinge; and
a second rail member fixedly connected to the first side panel and to a second portion of the at least one hinge.

22. The truck body of claim 21, wherein the second hinge comprises a slip hinge that comprises:
a first hinge element having a groove formed by opposing wall members, wherein one of the opposing wall members is shorter than the other of the opposing wall members;
a second hinge element having an arm member that extends into the groove and secures the second side panel to the floor panel.
